(19) United States
(12) Patent Application Publication
(10) Pub. No.: US 2018/0328771 A1
(43) Pub. Date: Nov. 15, 2018

(54) PULSED RADAR LEVEL GAUGE SYSTEM AND METHOD FOR REDUCED RELATIVE BANDWIDTH

(71) Applicant: Rosemount Tank Radar AB, Molnlycke (SE)

(72) Inventor: Olov Edvardsson, Linkoping (SE)

(21) Appl. No.: 15/591,256

(22) Filed: May 10, 2017

(51) Int. Cl. G01F 23/284

(52) U.S. Cl. CPC G01F 23/284

(57) ABSTRACT

A radar level gauge system comprising: pulse generating circuitry for generating an electromagnetic transmit signal in the form of a first pulse train formed by a time-sequence of substantially identical transmit pulses, each exhibiting a full period waveform; and an electromagnetic reference signal in the form of a second pulse train formed by a time-sequence of substantially identical reference pulses, each exhibiting a half period waveform; a propagation device arranged to propagate the transmit signal towards a product in a tank, and to return a surface reflection signal resulting from reflection of the transmit signal at a surface of the product; measurement circuitry for forming a measurement signal based on a time-correlation between the surface reflection signal and the reference signal; and processing circuitry connected to the measurement circuitry for determining the filling level based on the measurement signal.

### TECHNICAL FIELD OF THE INVENTION

The present invention relates to a pulsed radar level gauge system, and to a method of determining a filling level of a product in a tank.

### TECHNICAL BACKGROUND

Radar level gauge (RLG) systems are in wide use for determining filling levels in tanks. Radar level gauging is generally performed either by means of non-contact measurement, whereby electromagnetic signals are radiated towards the product in the tank, or by means of contact measurement, often referred to as guided wave radar (GWR), whereby electromagnetic signals are guided towards and into the product by a probe acting as a waveguide. The probe is generally arranged to extend vertically from the top towards the bottom of the tank.

An electromagnetic transmit signal is generated by a transceiver and propagated towards the surface of the product in the tank, and an electromagnetic reflection signal resulting from reflection of the transmit signal at the surface is received by the transceiver.

Based on the transmit signal and the reflection signal, the distance to the surface of the product can be determined.

Most radar level gauge systems on the market today are either so-called pulsed radar level gauge systems that determine the distance to the surface of the product in the tank based on the difference in time between transmission of a pulse and reception of its reflection at the surface of the product, or systems that determine the distance to the surface based on the frequency difference between a transmitted frequency-modulated signal and its reflection at the surface. The latter type of system is generally referred to as being of the FMCW (Frequency Modulated Continuous Wave) type.

For pulsed radar level gauge systems, time expansion techniques are generally used to resolve the time-of-flight.

In such pulsed radar level gauge systems a transmit signal in the form of a first pulse train with a first pulse repetition frequency is propagated towards the surface of the product in the tank, and a surface reflection signal resulting from reflection at the surface is received.

A reference signal in the form of a second pulse train having a second pulse repetition frequency, controlled to differ from the first pulse repetition frequency by a given frequency difference, is also generated.

At the beginning of a measurement operation, the transmit signal and the reference signal are synchronized to have the same phase. Due to the difference in pulse repetition frequency, the phase difference between the transmit signal and the reference signal will gradually increase during the measurement operation.

During the measurement operation, the surface reflection signal is correlated with the reference signal, to form a measurement signal based on a time correlation between the surface reflection signal and the reference signal. Based on the measurement signal, the filling level can be determined.

In most existing pulsed radar level gauge systems, the transmit signal is provided in the form of so-called DC-pulses, which may exhibit a frequency spectrum of 0 GHz to about 1 GHz with a substantial amount of the transmitted power being close to 0 GHz. Accordingly, the relative bandwidth of such DC-pulses may be well in excess of 200%, which requires a wideband coupling between the transceiver (typically on the outside of the tank) and the propagation device (typically on the inside of the tank).

However, design options for such a wideband coupling are limited, so that various interesting and otherwise advantageous coupling configurations are excluded.

It would therefore be desirable to provide a radar level gauge system allowing the use of a more narrow-band coupling between the transceiver and the propagation device.

### SUMMARY OF THE INVENTION

In view of the above, a general object of the present invention is to provide an improved radar level gauge system, in particular allowing the use of a more narrow-band coupling between the transceiver and the propagation device.

According to a first aspect of the present invention, it is provided a radar level gauge system for determining a filling level of a product in a tank, the radar level gauge system comprising: pulse generating circuitry for generating: an electromagnetic transmit signal in the form of a first pulse train having a first pulse repetition frequency, the first pulse train being formed by a time-sequence of substantially identical transmit pulses, each transmit pulse in the time-sequence of transmit pulses exhibiting a full period waveform; and an electromagnetic reference signal in the form of a second pulse train having a second pulse repetition frequency, the second pulse repetition frequency differing from the first pulse repetition frequency by a predetermined frequency difference, the second pulse train being formed by a time-sequence of substantially identical reference pulses, each reference pulse in the time-sequence of reference pulses exhibiting a half period waveform; a propagation device connected to the pulse generating circuitry and arranged to propagate the transmit signal towards a surface of the product in the tank, and to return a surface reflection signal resulting from reflection of the transmit signal at the surface; measurement circuitry connected to the propagation device and to the pulse generating circuitry for forming a measurement signal based on a time-correlation between the surface reflection signal and the reference signal; and processing circuitry connected to the measurement circuitry for determining the filling level based on the measurement signal.

The tank may be any container or vessel capable of containing a product, and may be metallic, or partly or completely non-metallic, open, semi-open, or closed. Furthermore, the filling level of the product in the tank may be determined directly by using a signal propagation device propagating the transmit signal towards the product inside the tank, or indirectly by using a propagation device disposed inside a so-called chamber located on the outside of the tank, but being in fluid connection with the inside of the tank in such a way that the level in the chamber corresponds to the level inside the tank.

The pulse generating circuitry may include at least one voltage controlled oscillator circuit, which may comprise a crystal oscillator. Alternatively, or in addition, the pulse generating circuitry may comprise at least one resonator element formed by electronic circuitry comprising a portion with inductive characteristics and a portion with capacitive characteristics.

It should be noted that any one or several of the means comprised in the processing circuitry may be provided as either of a separate physical component, separate hardware blocks within a single component, or software executed by one or several microprocessors.

The “measurement circuitry” may, for example, comprise a mixer and the measurement signal may be formed by mixing the reference signal and the surface reflection signal such that a signal indicating time correlation is generated each time a reference pulse passes the time domain for the surface reflection signal. As will be evident to those skilled in the relevant art, the measurement circuitry may, in principle, include any circuitry capable of time-correlating two signals. Various types of such circuitry are well-known from, for example, time-expansion oscilloscopes.

That each transmit pulse exhibits a “full period waveform” should, in the context of the present application, be understood to mean that each transmit pulse exhibits a waveform shape with a crest and a trough.

Analogously, each reference pulse exhibiting a “half period waveform” should, in the context of the present application, be understood to exhibit a waveform shape with only one of a crest and a trough.

The determination of the filling level may be additionally based on the above-mentioned predetermined frequency difference.

In embodiments where the propagation device is a probe, it should be understood that the probe is a waveguide designed for guiding electromagnetic signals. The probe may be rigid or flexible and may advantageously be made of metal, such as stainless steel.

The present invention is based on the realization that the desired narrower relative bandwidth can be achieved by providing the transmit pulses as full period waveform pulses, while providing the reference pulses as half period waveform pulses.

The present inventor has further realized that embodiments of the pulsed radar level gauge system providing the desired narrower relative bandwidth can be achieved through simple modification of existing pulsed radar level gauge systems, using so-called DC-pulses.

According to various embodiments of the present invention, a pulse width of each transmit pulse in the time-sequence of transmit pulses may be at least approximately twice a pulse width of each reference pulse in the time-sequence of reference pulses. In these embodiments, the time-correlation of the surface reflection signal and the reference signal may be simplified.

Furthermore, the above-mentioned half period waveform may advantageously be substantially identical to one half of the above-mentioned full period waveform.

In other words, a reference pulse may be substantially identical to one half of a transmit pulse.

Moreover, each transmit pulse in the time-sequence of transmit pulses may be sinusoidal; and each reference pulse in the time-sequence of reference pulses may be sinusoidal.

Sinusoidal pulses in general require a narrower bandwidth than square wave pulses, which may be advantageous for embodiments of the present invention.

It should be understood that the term “sinusoidal” is not limited to a simple sine wave, but more broadly denotes a smooth waveform that can be formed by superimposing a limited number of sine waves with different frequencies.

In various embodiments of the radar level gauge system according to the present invention, furthermore, the pulse generating circuitry may comprise a first pulse generator for generating an intermediate signal in the form of an intermediate pulse train having the first pulse repetition frequency, the intermediate pulse train being formed by a time-sequence of substantially identical intermediate pulses, each intermediate pulse in the time-sequence of intermediate pulses exhibiting a half period waveform; and a waveform converter connected to the first pulse generator for receiving the time-sequence of intermediate pulses and providing the time-sequence of transmit pulses.

Through this configuration of the radar level gauge system, an existing pulsed radar level gauge system layout can be modified to achieve a narrower bandwidth with very limited intervention. For instance, existing pulse generating circuitry for generating DC-pulses can be modified through addition of the above-mentioned waveform converter, to convert the half period waveform DC-pulses to full period waveform pulses exhibiting a considerably smaller relative bandwidth.

In embodiments, the above-mentioned waveform converter may comprise differentiator circuitry for differentiating (forming a time derivative of) the intermediate half period waveform signal.

The differentiator circuitry may include an active or a passive differentiator.

In its simplest form, which is still estimated to exhibit sufficient performance, the differentiator circuitry may be provided in the form of a coupling capacitor connected in series between the first pulse generator and the propagation device, possibly in combination with one or a few further passive components. As is well known, a few extra circuit elements can be included to improve the result of a pulse forming circuit. As an alternative or complement to discrete passive circuit elements, distributed elements like a piece of transmission line can be used.

In other embodiments of the radar level gauge system according to the present invention, the waveform converter may comprise delay circuitry connected to the first pulse generator for providing a first intermediate signal with a first delay, and a second intermediate signal with a second delay different from the first delay; and a differential amplifier connected to the delay circuitry to receive the first intermediate signal and the second intermediate signal, and to provide the transmit signal as a difference signal between the first intermediate signal and the second intermediate signal.

The delay circuitry may include parallel branches with different delay connected to the output of the pulse generator. One of the delays may be substantially zero (constituted by a simple conductor, such as a circuit board trace).

In various embodiments of the radar level gauge system according to the present invention, the pulse generating circuitry may further comprise: a second pulse generator for generating the reference signal; and timing circuitry for controlling the first pulse generator and the second pulse generator to provide the predetermined frequency difference.

In other embodiments, the radar level gauge system may comprise a single pulse generator for generating the transmit pulses (the intermediate pulses) and the reference pulses, and a controllable delay circuit for controllably delaying at least one of the transmit signal (intermediate signal) and the reference signal.

Furthermore, the above-mentioned measurement circuitry may comprise correlating circuitry for time-correlating the surface reflection signal and the reference signal to form a correlation signal, on which the measurement signal is based.

One example of such correlating circuitry is sampling circuitry for sampling the surface reflection signal at sampling times determined by the timing of the reference pulses. For instance, the reference pulses may be used to trigger the sampling circuitry.

In embodiments, the measurement circuitry may further comprise integrating circuitry for integrating the correlation signal to form the measurement signal.

Integration of the correlation signal may allow use of the same kind of processing of the measurement signal as in existing pulsed radar level gauge systems. In addition, the integration is expected to remove noise, especially short noise “spikes”.

In various embodiments, furthermore, the radar level gauge system according to the present invention may further comprise a non-conducting signal coupling arrangement connected between the propagation device, and the pulse generating circuitry and the measurement circuitry.

The non-conducting signal coupling arrangement may, for instance, comprise a reactive signal coupling for coupling the transmit signal from transceiver to propagation device (typically probe). The reactive signal coupling may use inductive and/or capacitive coupling.

For a so-called guided wave radar level gauge system (comprising a probe), the provision of such a non-conductive signal coupling, may allow the probe to be grounded through direct conductive connection to a metallic tank structure. This, in turn, provides for a very robust attachment of the probe to the tank, and also considerably increases the tolerance of the radar level gauge system to current spikes, such as spikes due to lightning. Examples of non-conductive signal coupling configurations that may be suitable are described in US 2009/0085794, which is hereby incorporated by reference in its entirety.

According to a second aspect of the present invention, it is provided a method of determining a filling level of a product in a tank using a radar level gauge system comprising pulse generating circuitry, a propagation device, measurement circuitry, and processing circuitry, the method comprising the steps of: generating, by the pulse generating circuitry, an electromagnetic transmit signal in the form of a first pulse train having a first pulse repetition frequency, the first pulse train being formed by a time-sequence of substantially identical transmit pulses, each transmit pulse in the time-sequence of transmit pulses exhibiting a full period waveform; generating, by the pulse generating circuitry, an electromagnetic reference signal in the form of a second pulse train having a second pulse repetition frequency, the second pulse repetition frequency differing from the first pulse repetition frequency by a predetermined frequency difference, the second pulse train being formed by a time-sequence of substantially identical reference pulses, each reference pulse in the time-sequence of reference pulses exhibiting a half period waveform; propagating, by the propagation device, the transmit signal towards a surface of the product in the tank; propagating, by the propagation device, a surface reflection signal resulting from reflection of the transmit signal at the surface; receiving, by the measurement circuitry, the surface reflection signal; time-correlating, by the measurement circuitry, the surface reflection signal and the reference signal to form a measurement signal; and determining, by the processing circuitry, the filling level based on the measurement signal.

In embodiments, the method may further comprise the steps of: non-conductively coupling the transmit signal between the pulse generating circuitry and the propagation device; and non-conductively coupling the surface reflection signal between the propagation device and the measurement circuitry.

In summary, the present invention thus relates to a radar level gauge system comprising: pulse generating circuitry for generating an electromagnetic transmit signal in the form of a first pulse train formed by a time-sequence of substantially identical transmit pulses, each exhibiting a full period waveform; and an electromagnetic reference signal in the form of a second pulse train formed by a time-sequence of substantially identical reference pulses, each exhibiting a half period waveform; a propagation device arranged to propagate the transmit signal towards a product in a tank, and to return a surface reflection signal resulting from reflection of the transmit signal at a surface of the product; measurement circuitry for forming a measurement signal based on a time-correlation between the surface reflection signal and the reference signal; and processing circuitry connected to the measurement circuitry for determining the filling level based on the measurement signal.

### BRIEF DESCRIPTION OF THE DRAWINGS

These and other aspects of the present invention will now be described in more detail, with reference to the appended drawings showing example embodiments of the invention, wherein:

FIG. 1 schematically illustrates an exemplary tank arrangement comprising a radar level gauge system according to an embodiment of the present invention;

FIG. 2 is schematic illustration of the measurement unit comprised in the radar level gauge system in FIG. 1;

FIG. 3 is a schematic block diagram of the transceiver comprised in a radar level gauge system according to an embodiment of the present invention;

FIG. 4A schematically illustrates examples of the transmit signal, the surface reflection signal and the reference signal;

FIG. 4B is a partial enlarged view of a portion of the transmit signal and the reference signal in FIG. 4A;

FIG. 4C is an illustration of the bandwidth of the transmit signal as compared to conventional DC-pulses;

FIG. 4D schematically illustrates the measurement signal resulting from time-correlation of the surface reflection signal and the reference signal in FIG. 4A;

FIG. 5A is a schematic block diagram of a first example configuration of a pulse forming circuit for generating the transmit signal;

FIG. 5B is a schematic block diagram of a second example configuration of a pulse forming circuit for generating the transmit signal;

FIG. 6A schematically shows a first example configuration of the connection arrangement comprised in the radar level gauge system in FIG. 1;

FIG. 6B is a schematic circuit diagram of the connection arrangement in FIG. 6A;

FIG. 6C is a graph schematically illustrating signal attenuation simulated for an example configuration of the connection arrangement comprised in the radar level gauge system according to embodiments of the invention as a function of frequency; and

FIG. 7 is a flow-chart schematically illustrating an example embodiment of the method according to the present invention.

### DETAILED DESCRIPTION OF AN EXAMPLE EMBODIMENT OF THE INVENTION

In the present detailed description, various embodiments of the present invention are mainly discussed with reference to a pulsed radar level gauge system with a non-conductive coupling between transceiver and probe.

It should be noted that this by no means limits the scope of the present invention, which also covers a pulsed radar level gauge system with other couplings between transceiver and probe, such as a conventional conductive coupling between transceiver and probe.

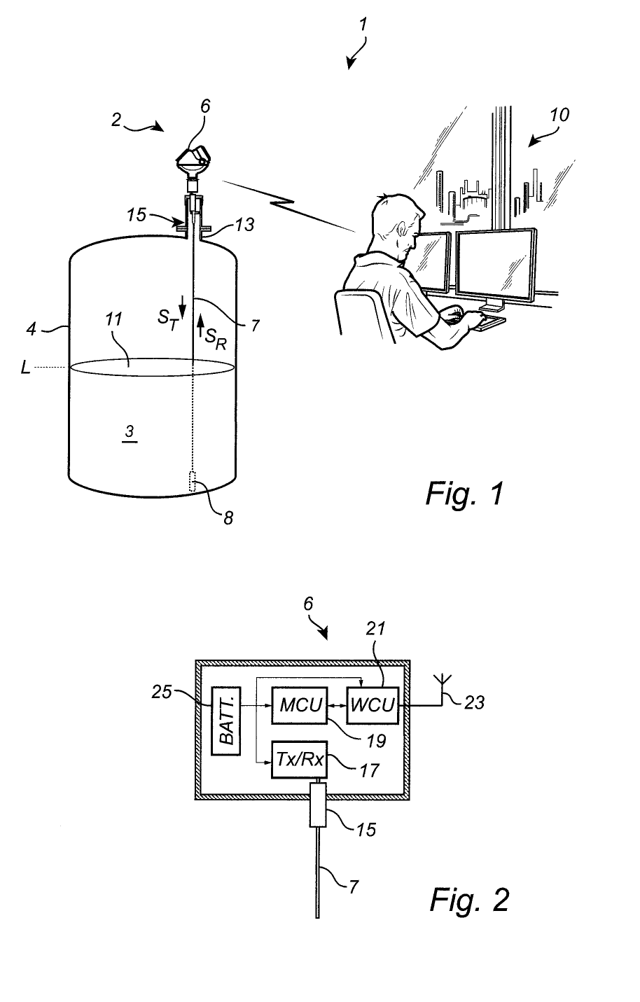

FIG. 1 schematically shows a level measuring system 1 comprising a radar level gauge system 2 according to an example embodiment of the present invention, and a host system 10 illustrated as a control room.

The radar level gauge system 2 of GWR (Guided Wave Radar) type is installed at a tank 4 having a tubular mounting structure 13 (often referred to as a “nozzle”) extending substantially vertically from the roof of the tank 4.

The radar level gauge system 2 is installed to measure the filling level of a product 3 in the tank 4. The radar level gauge system 2 comprises a measuring unit 6 and a propagation device in the form of a single conductor probe 7 extending from the measuring unit 6, through the tubular mounting structure 13, towards and into the product 3. In the example embodiment in FIG. 1, the single conductor probe 7 is a wire probe, that has a weight 8 attached at the end thereof to keep the wire straight and vertical. The probe 7 is grounded through conductive electric connection to a metallic structure, here the tubular mounting structure 13, of the tank 4, and the radar level gauge system 2 comprises a connection arrangement 15 for non-conductive transmission of electromagnetic signals between the measurement unit 6 and the probe 7. The connection arrangement 15 will be described in greater detail further below.

By analyzing transmitted signals S_{T} being guided by the probe 7 towards the surface 11 of the product 3, and reflected signals S_{R} traveling back from the surface 11, the measurement unit 6 can determine the filling level of the product 3 in the tank 4. It should be noted that, although a tank 4 containing a single product 3 is discussed herein, the distance to any material interface along the probe can be measured in a similar manner.

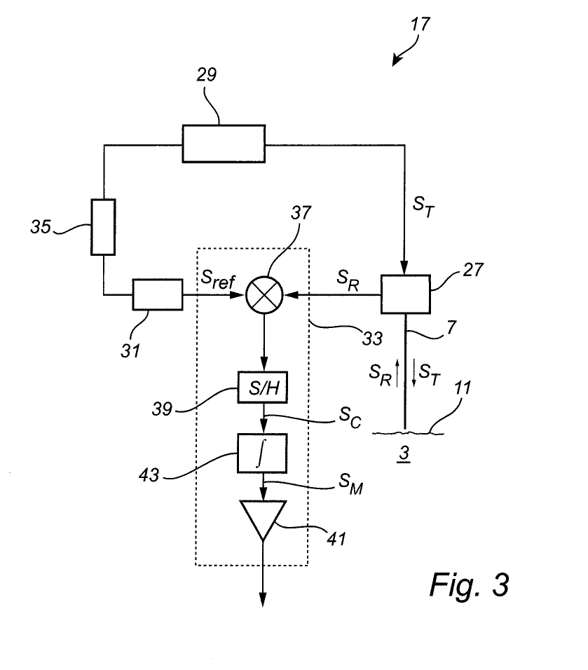

The radar level gauge system in FIG. 1 will now be described in more detail with reference to the schematic block diagram in FIG. 2.

Referring to the schematic block diagram in FIG. 2, the measurement unit 6 of the radar level gauge system 2 in FIG. 1 comprises a transceiver 17, a measurement control unit (MCU) 19, a wireless communication control unit (WCU) 21, a communication antenna 23, an energy store, such as a battery 25, and the connection arrangement 15.

As is schematically illustrated in FIG. 2, the MCU 19 controls the transceiver 17 to generate, transmit and receive electromagnetic signals. The transmitted signals pass through the tank connection arrangement 15 to the probe 7, and the received signals pass from the probe 7 through the tank connection arrangement 15 to the transceiver 17.

The MCU 19 determines the filling level of the product 3 in the tank 4 and provides a value indicative of the filling level to an external device, such as a control center, from the MCU 19 via the WCU 21 through the communication antenna 23. The radar level gauge system 1 may advantageously be configured according to the so-called WirelessHART communication protocol (IEC 62591).

Although the measurement unit 6 is shown to comprise an energy store 25 and to comprise devices (such as the WCU 21 and the communication antenna 23) for allowing wireless communication, it should be understood that power supply and communication may be provided in a different way, such as through communication lines (for example 4-20 mA lines).

The local energy store need not (only) comprise a battery, but may alternatively, or in combination, comprise a capacitor or super-capacitor.

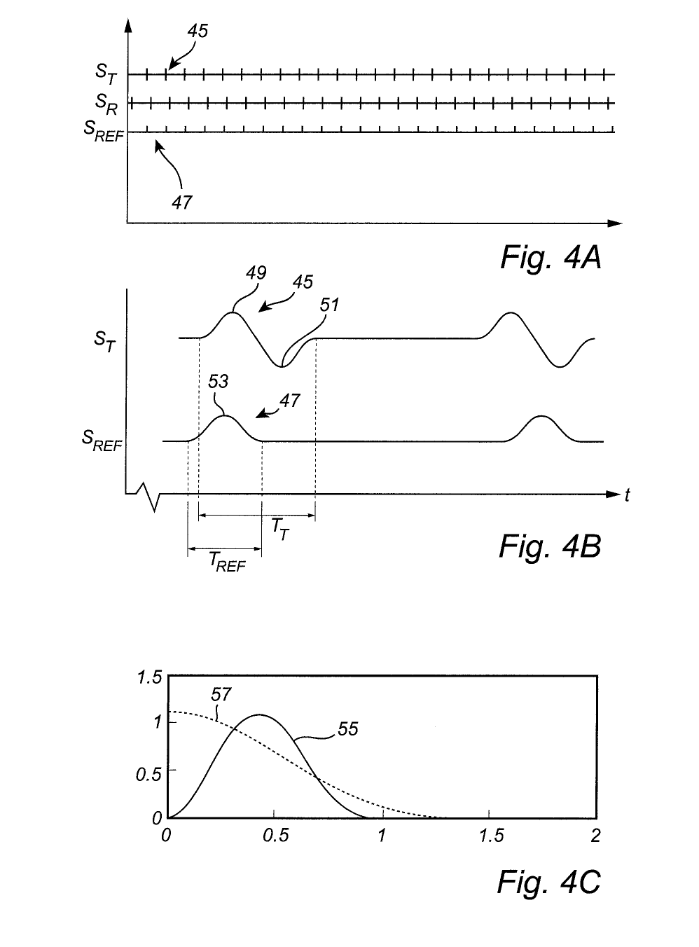

The radar level gauge system 2 in FIG. 1 will now be described in greater detail with reference to the schematic block diagram in FIG. 3.

Referring now to FIG. 3, there is shown a more detailed block diagram of the transceiver 17 in FIG. 2.

As is schematically shown in FIG. 3, the transceiver 17 comprises a transmitter branch for generating and transmitting a transmit signal S_{T} towards the surface 11 of the product 3 in the tank, and a receiver branch for receiving and operating on the reflected signal S_{R} resulting from reflection of the transmit signal S_{T} at the surface 11 of the product 3. As is indicated in FIG. 3, the transmitter branch and the receiver branch are both connected to a directional coupler 27 to direct signals from the transmitter branch to the probe 7 and to direct reflected signals being returned by the probe 7 to the receiver branch.

As is schematically indicated in FIG. 3, the transceiver 17 comprises pulse generating circuitry, here in the form of a first pulse forming circuit 29, a second pulse forming circuit 31, and a timing control unit 35 for controlling the timing relationship between the transmit signal output by the first pulse forming circuit 29 and the frequency shifted reference signal S_{REF} output by the second pulse forming circuit 31.

The transmitter branch comprises the first pulse forming circuit 29, and the receiver branch comprises the second pulse forming circuit 31 and measurement circuitry 33.

As is schematically indicated in FIG. 3, the measurement circuitry 33 comprises a time-correlator, here in the form of a mixer 37, a sample-and-hold circuit 39 and amplifier circuitry 41. In embodiments of the present invention, the measurement circuitry 33 may further comprise an integrator 43.

Additionally, as was briefly described above with reference to FIG. 2, the radar level gauge system 1 comprises processing circuitry 19 (not shown in FIG. 3) that is connected to the measurement circuitry 33 for determining the filling level of the product 3.

When the radar level gauge system 1 in FIG. 3 is in operation to perform a filling level determination, a time correlation is performed in the mixer 37 between the surface reflection signal S_{R} and the reference signal S_{REF} that is output by the second pulse forming circuit 31. The reference signal S_{REF} is a pulse train with a pulse repetition frequency that controlled to differ from the pulse repetition frequency of the transmit signal S_{T}, by a predetermined frequency difference Δf. When a measurement sweep starts, the reference signal S_{REF} and the transmit signal S_{T} are in phase, and then the time until the reference signal “catches up with” the reflected signal S_{R} is determined. From this time and the frequency difference Δf, the distance to the surface 3 can be determined.

The time-expansion technique that was briefly described in the previous paragraph is well known to the person skilled in the art, and is widely used in pulsed radar level gauge systems.

As is clear from the above discussion, the output from the mixer 37 will be a sequence of values, where each value represents a time correlation between a pulse of the reference signal S_{REF} and the surface reflection signal S_{R}. The values in this sequence of values are tied together to form a continuous signal using the sample-and-hold circuit 39.

In this context it should be noted that the sample-and-hold amplifier 39 is simply an illustrative example of a device capable of maintaining a voltage level over a given time, and that there are various other devices that can provide the desired functionality, as is well known to the person skilled in the art.

In the example embodiment of FIG. 3, the time-correlated signal—the correlation signal S_{c}—output from the sample-and-hold circuit 39 is provided to an integrator to form a measurement signal S_{M} from which the filling level is determined by the MCU 19, following amplification of the measurement signal S_{M} by the low noise amplifier LNA 41.

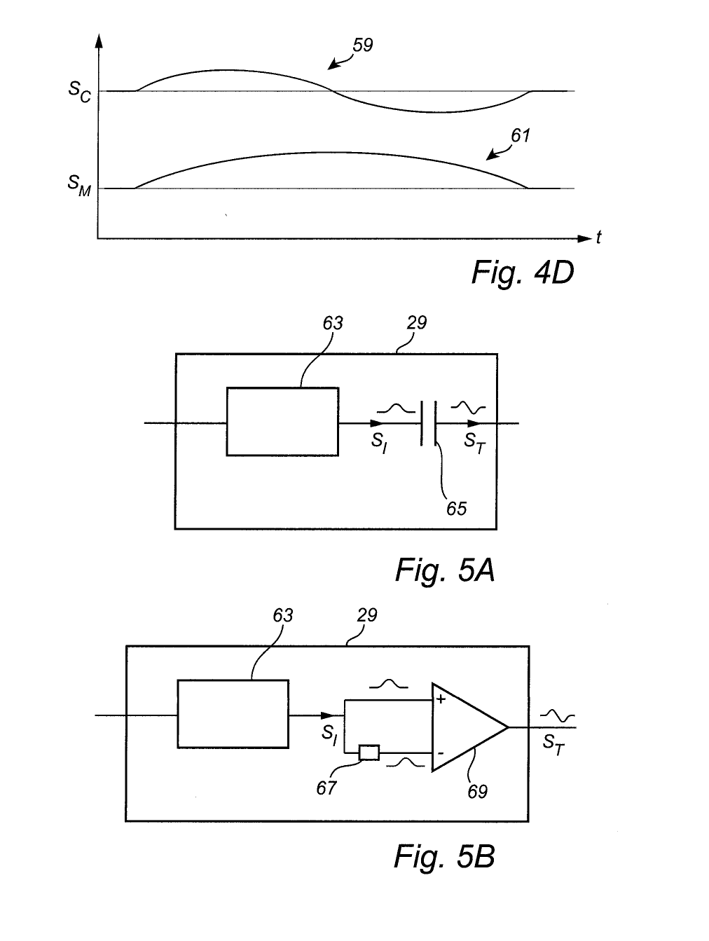

FIG. 4A is a simplified timing diagram schematically showing the relative timing of the transmit signal S_{T}, the reflected signal S_{R}, and the reference signal S_{REF}.

As is schematically indicated in FIG. 4A, the transmit signal S_{T}, formed by transmit pulses 45, and the reference signal S_{REF}, formed by reference pulses 47, are controlled by the timing circuitry 21 to be in phase at the start of the measurement sweep. A full measurement sweep may typically be defined by the difference frequency Δf, since the transmit signal S_{T} and the reference signal S_{REF}, in this particular example, need to be in phase at the start of a new measurement sweep. As is also schematically indicated in FIG. 4A, the surface reflection signal S_{R} has the same pulse repetition frequency as the transmit signal S_{T}, but lags behind the transmit signal S_{T} with a time corresponding to the time-of-flight indicative of the distance to the surface 11 of the product 3.

The reference signal S_{REF} is initially in phase with the transmit signal, but will, due to its lower pulse repetition frequency “run away from” the transmit signal S_{T} and “catch up with” the surface reflection signal S_{R}.

When the time-varying phase difference between the transmit signal S_{T} and the reference signal S_{REF} corresponds to the time-of-flight of the reflected signal S_{R}, there will be a time-correlation between pulses of the reference signal S_{REF} and pulses of the surface reflection signal S_{R}. This time-correlation, results in a time-expanded correlation signal S_{c}, which can, in turn, be converted to a measurement signal S_{M} as will be described further below with reference to FIG. 4D.

First, however, example waveforms of the transmit pulses 45 and the reference pulses 47 will be described with reference to the schematic magnified view in FIG. 4B. As is shown in FIG. 4B, each transmit pulse 45 exhibits a full period waveform having a crest 49 and a trough 51, and each reference pulse 47 exhibits a half period waveform (here the half period with a crest 53). Further, the pulse time T_{T} of each transmit pulse 45 is at least approximately twice the pulse time T_{REF} of each reference pulse 47.

As was explained in the Summary section, the full period waveform of the transmit pulses 45 considerably reduces the relative bandwidth of the transmit signal S_{T} as compared to conventional DC-pulses (such as the reference pulses 47 shown in FIG. 4B).

FIG. 4C is a diagram showing simulations of the power spectrum 55 of the transmit pulse 45, and the power spectrum 57 of the reference pulse 47. It is immediately clear from FIG. 4C that the relative bandwidth of the transmit signal S_{T} (and the surface reflection signal S_{R}) is considerably smaller than the relative bandwidth of the reference signal S_{REF} (conventional DC-pulses).

Referring now to FIG. 4D, the above-mentioned correlation signal S_{c} and measurement signal S_{M} are schematically illustrated in a diagram. The correlation signal S_{c} results from direct time-correlation between the surface reflection signal S_{R} (surface reflection pulses each exhibiting a full period waveform) and the reference signal S_{REF} (reference pulses each exhibiting a half period waveform). As is schematically shown in FIG. 4D, the correlation signal S_{c} is a time-expanded full waveform signal 59.

Following integration by integrator 43 and amplification by LNA 41, the measurement signal S_{M} in FIG. 4D is obtained. As can be seen in FIG. 4D, the measurement signal S_{M} is a time-expanded half waveform signal 61, which can be subjected to conventional signal processing, implemented in pulsed radar level gauge systems in which DC-pulses are transmitted towards the product in the tank.

It should be noted that the present invention is equally applicable to pulsed level gauge systems in which the time-varying phase difference between the transmit signal S_{T} and the reference signal S_{REF} is achieved by providing the reference signal as the transmit signal being delayed by a time varying delay, or vice-versa.

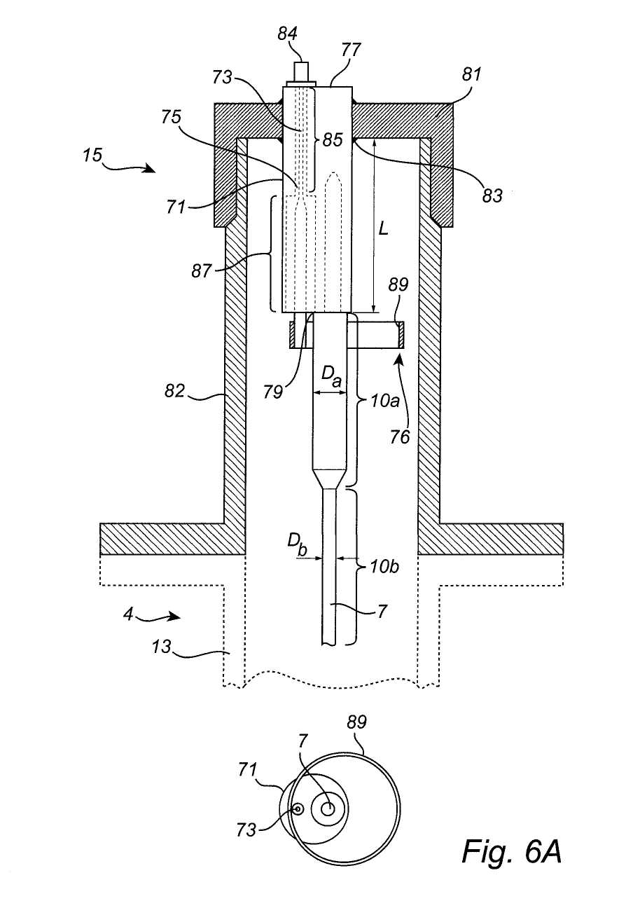

Different example configurations of the first pulse generator 29 in FIG. 3 for generating the transmit pulses 45 exhibiting the full period waveform shown in FIG. 4B will now be described with reference to FIG. 5A and FIG. 5B.

Referring first to FIG. 5A, the first pulse forming circuit 29 comprises a first pulse generator 63 and a waveform converter, in the form of differentiating circuitry, here a series coupling capacitor 65. As is schematically indicated in FIG. 5A, the first pulse generator 63 generates an intermediate signal S_{I} with half period waveform pulses. Due to the time derivation function of the series capacitor 65, the half period waveform pulses of the intermediate signal S_{I} are converted to the full period waveform pulses of the transmit signal S_{T}.

Turning to FIG. 5B, the first pulse forming circuit 29 comprises a first pulse generator 63 and a waveform converter including a delay circuit 67 and a differential amplifier 69. As is schematically indicated in FIG. 5B, an undelayed version of the intermediate signal S_{I} is provided to the positive input of the differential amplifier 69, and a delayed version of the intermediate signal S_{I} is provided to the negative input of the differential amplifier. The delay circuit 67 is configured to provide a delay corresponding to the pulse width of the pulses of the intermediate signal S_{I}. As is indicated, the differential amplifier will output the transmit signal S_{T} as a pulse train of full period waveform transmit pulses.

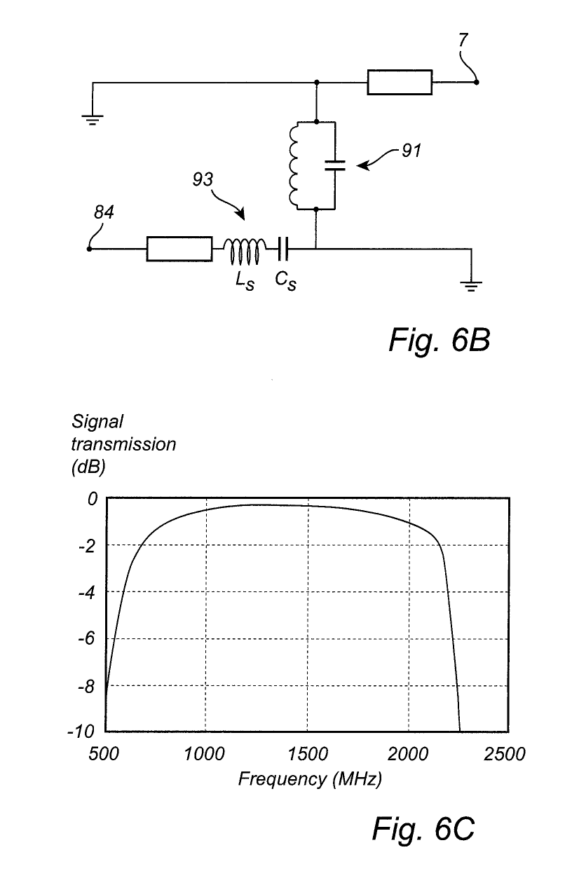

A first example of the connection arrangement 15 comprised in the radar level gauge system 2 in FIG. 1 will now be described with reference to FIG. 6A. As is schematically shown in FIG. 6A, the connection arrangement 15 comprises an electrically conductive feed-through member 71, a signal conductor 73, a dielectric 75, and a tank coupling arrangement 76.

The feed-through member 71 extends from a first end 77 on an outside of the tank 4 to a second end 79 on an inside of the tank 4. The probe 7 is conductively connected to the feed-through member 71, and extends towards the product in the tank 4 from the second end 79 of the feed-through member 71. In the example configuration of the connection arrangement 15 in FIG. 6A, the probe 7 comprises an upper probe part 10a with a first probe diameter Dₐ, and a lower probe part 10b with a second probe diameter D_{b}. As is schematically indicated in FIG. 6A, the first probe diameter Dₐ is greater than the second probe diameter D_{b}. The upper probe part 10a, which is here shown to be screwed into the feed-through member 71, acts as an impedance transformer to contribute to the bandwidth that is obtained by the connection arrangement 15.

The feed-through member 71 is in conductive contact with a conductive lid 81 at a grounding position 83. As is indicated in FIG. 6A, the grounding position 83 is spaced apart from the second end 79 of the feed-through member 71 by a distance L substantially corresponding to a quarter of the wavelength of the transmit signal S_{T} at a center frequency of the transmit signal.

In the example configuration of the connection arrangement 15 shown in FIG. 6A, the feed-through member 71 is in conductive contact with the tubular mounting structure 13 via a welded connection between the feed-through member 51 and the lid 81, a threaded connection between the lid 81 and a tubular member 82 fixed to the tubular mounting structure (nozzle) 13 by bolts (not shown in FIG. 6A). It should be noted that this is only one exemplary way of achieving an electrically conductive contact between the feed-through member 71 and a conductive structure (here the tubular mounting structure 13) of the tank 4, and that there are many other ways of achieving the desired conductive contact.

The signal conductor 73 extends through the feed-through member 71 from the outside of the tank 4 to the inside of the tank 4. In the example configuration schematically shown in FIG. 6A, the signal conductor 73 is connected to a connector 84 at the outside of the tank 4. When the measurement unit 6 has been connected to the connection arrangement 15, the transceiver 17 will be connected to the connector 84 to provide the transmit signal S_{T} to the signal conductor 73.

As is schematically indicated in FIG. 6A, the dielectric 75 is arranged between the signal conductor 73 and the feed-through member 71 to prevent conductive contact between the signal conductor 73 and the feed-through member 71. The signal conductor 73, the dielectric 75, and the feed-through member 71 together form a coaxial line having a first coaxial line portion 85 having a first thickness of the dielectric 75, and a second coaxial line portion 87 having a second, greater, thickness of the dielectric 75. The second coaxial line portion 87 acts as an impedance transformer contributing to the bandwidth of the connection arrangement 15.

The tank coupling arrangement 76 is connected to the signal conductor 73 on the inside of the tank, and is configured to provide inductive and capacitive coupling in series between the signal conductor 73 and the inner wall of the tubular member 82. In the example configuration of the connection arrangement in FIG. 6A, the tank coupling arrangement 76 comprises radially extending electrically conductive coupling member, here provided in the form of a bent metal ribbon 89 encircling the upper probe portion 8a of the probe 7. The ribbon 89 is arranged and configured to form a parallel plate capacitor together with the inner wall of the tubular member 82. In particular, the dimensions (vertical extension and radius of curvature) of the metal ribbon 89, and the distance between the metal ribbon 89 and the inner wall of the tubular member 82 are selected to achieve a desired capacitance of the capacitor formed by the ribbon 89, the tubular member 82, and the dielectric between the ribbon 89 and the tubular member 82. The desired capacitance may be in the range of 0.1 pF to 10 pF. It will be straight-forward for one of ordinary skill in the relevant art to dimension the coupling member (ribbon 89), and/or to position the coupling arrangement 15 in relation to the tubular member 82 to achieve a capacitance that is desired for a particular frequency range of the transmit signal S_{T}.

In the example embodiment in FIG. 6A, the tubular member 82 is delivered as a part of the radar level gauge system 2. This allows the supplier of the radar level gauge system 2 to precisely control critical dimensions (in particular the distance between the ribbon 89 and the inner wall of the tubular member 82). It should be noted, however, that this distance, and other dimensions, can be set by the customer and/or controlled by the supplier in other ways.

FIG. 6B is a simplified circuit schematic illustrating the electrical filter properties of the connection arrangement 15 in FIG. 6A. With the dimensions indicated in FIG. 6A and described above, the coaxial line formed by the tubular member 82 and the feed-through member 71 between the grounding position 83 and the second end 79 (which electrically corresponds to the uppermost portion of the probe 7) forms a parallel resonant circuit 91. The tank coupling arrangement 76 forms, together with the tubular member 82, a series resonant circuit 93 with substantially the same resonance frequency as the parallel resonant circuit 91.

As is schematically indicated in FIG. 6B, the series resonant circuit 93 is characterized by a series inductance Lₛ and a series capacitance Cₛ. Simulations give that the series inductance should preferably be in the range of 0.1 nH to 10 nH, and that the series capacitance should preferably be in the range of 0.1 pF to 10 pF.

A simulation performed for dimensions such as those shown in FIG. 6A resulted in the signal transmission (from the connector 64 to the lower probe portion 8b of the probe 7) in dB as a function of frequency is shown in FIG. 6C.

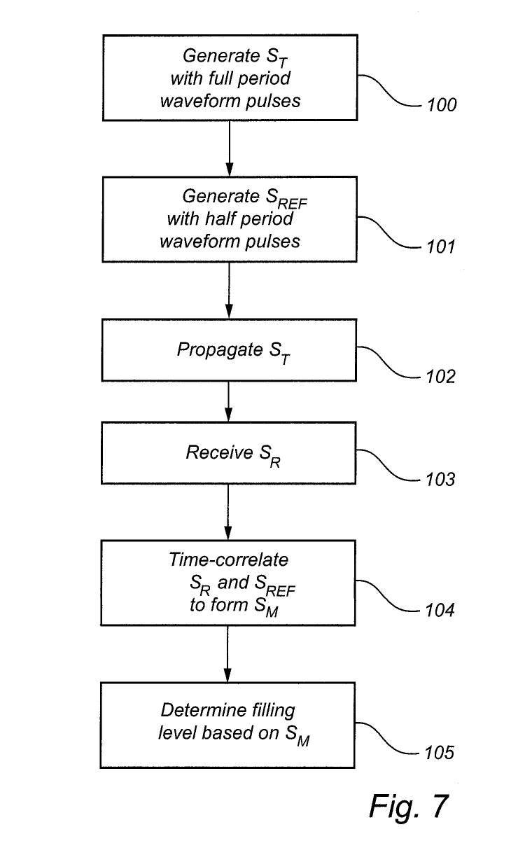

An example embodiment of the method according to the present invention will now be described with reference to the flow-chart in FIG. 7.

In step 100, the transmit signal S_{T} is generated as a pulse train of transmit pulses 45, each exhibiting a full period waveform, and thus having a relatively small relative bandwidth.

In step 101, taking place at the same time as step 100, the reference signal S_{REF} is generated as a pulse train of reference pulses 47, each exhibiting a half period waveform.

In step 102, the transmit signal S_{T} is propagated towards the surface 11 of the product 3 in the tank 4, and in step 103, the surface reflection signal S_{R} resulting from reflection at the surface 11 of the transmit signal S_{T} is received by the transceiver 17.

In step 104, the surface reflection signal S_{R} and the reference signal S_{REF} are time-correlated to form the time-expanded measurement signal S_{M}, and in step 105, the filling level is determined based on the measurement signal S_{M} and the frequency difference Δf between the pulse repetition frequency of the transmit signal S_{T} and the pulse repetition frequency of the reference signal S_{REF}.

The person skilled in the art realizes that the present invention by no means is limited to the preferred embodiments described above. For example, many other configurations of the connection arrangement 15 may be feasible. In particular, many other configurations of the tank coupling arrangement 76 and the connection of the feed-through member 71 to the tank 4 will be possible. Moreover, many other pulse shapes of the transmit signal S_{T} and the reference signal S_{REF} may be beneficial.

1. A radar level gauge system for determining a filling level of a product in a tank, said radar level gauge system comprising:
pulse generating circuitry for generating:
an electromagnetic transmit signal in the form of a first pulse train having a first pulse repetition frequency, said first pulse train being formed by a time-sequence of substantially identical transmit pulses, each transmit pulse in said time-sequence of transmit pulses exhibiting a full period waveform; and
an electromagnetic reference signal in the form of a second pulse train having a second pulse repetition frequency, said second pulse repetition frequency differing from said first pulse repetition frequency by a predetermined frequency difference, said second pulse train being formed by a time-sequence of substantially identical reference pulses, each reference pulse in said time-sequence of reference pulses exhibiting a half period waveform;
a propagation device connected to said pulse generating circuitry and arranged to propagate said transmit signal towards a surface of said product in the tank, and to return a surface reflection signal resulting from reflection of said transmit signal at said surface;
measurement circuitry connected to said propagation device and to said pulse generating circuitry for forming a measurement signal based on a time-correlation between said surface reflection signal and said reference signal; and
processing circuitry connected to said measurement circuitry for determining said filling level based on said measurement signal.

2. The radar level gauge system according to claim 1, wherein a pulse width of each transmit pulse in said time-sequence of transmit pulses is at least approximately twice a pulse width of each reference pulse in said time-sequence of reference pulses.

3. The radar level gauge system according to claim 1, wherein said half period waveform is substantially identical to one half of said full period waveform.

4. The radar level gauge system according to claim 1, wherein:
each transmit pulse in said time-sequence of transmit pulses is sinusoidal; and
each reference pulse in said time-sequence of reference pulses is sinusoidal.

5. The radar level gauge system according to claim 1, wherein said pulse generating circuitry comprises:
a first pulse generator for generating an intermediate signal in the form of an intermediate pulse train having said first pulse repetition frequency, said intermediate pulse train being formed by a time-sequence of substantially identical intermediate pulses, each intermediate pulse in said time-sequence of intermediate pulses exhibiting a half period waveform; and
a waveform converter connected to said first pulse generator for receiving said time-sequence of intermediate pulses and providing said time-sequence of transmit pulses.

6. The radar level gauge system according to claim 5, wherein said waveform converter comprises differentiator circuitry.

7. The radar level gauge system according to claim 6, wherein said differentiator circuitry comprises a passive differentiator.

8. The radar level gauge system according to claim 7, wherein said passive differentiator comprises a coupling capacitor connected in series between said first pulse generator and said propagation device.

9. The radar level gauge system according to claim 5, wherein said waveform converter comprises:
delay circuitry connected to said first pulse generator for providing a first intermediate signal with a first delay, and a second intermediate signal with a second delay different from said first delay; and
a differential amplifier connected to said delay circuitry to receive said first intermediate signal and said second intermediate signal, and to provide said transmit signal as a difference signal between said first intermediate signal and said second intermediate signal.

10. The radar level gauge system according to claim 5, wherein said pulse generating circuitry further comprises:
a second pulse generator for generating said reference signal; and
timing circuitry for controlling said first pulse generator and said second pulse generator to provide said predetermined frequency difference.

11. The radar level gauge system according to claim 1, wherein said measurement circuitry comprises correlating circuitry for time-correlating said surface reflection signal and said reference signal to form a correlation signal.

12. The radar level gauge system according to claim 11, wherein said measurement circuitry further comprises integrating circuitry for integrating said correlation signal to form said measurement signal.

13. The radar level gauge system according to claim 1, wherein said propagation device is a probe.

14. The radar level gauge system according to claim 13, further comprising a non-conducting signal coupling arrangement connected between said probe, and said pulse generating circuitry and said measurement circuitry.

15. The radar level gauge system according to claim 13, wherein said probe is grounded.

16. A method of determining a filling level of a product in a tank using a radar level gauge system comprising pulse generating circuitry, a propagation device, measurement circuitry, and processing circuitry, said method comprising the steps of:
generating, by said pulse generating circuitry, an electromagnetic transmit signal in the form of a first pulse train having a first pulse repetition frequency, said first pulse train being formed by a time-sequence of substantially identical transmit pulses, each transmit pulse in said time-sequence of transmit pulses exhibiting a full period waveform;
generating, by said pulse generating circuitry, an electromagnetic reference signal in the form of a second pulse train having a second pulse repetition frequency, said second pulse repetition frequency differing from said first pulse repetition frequency by a predetermined frequency difference, said second pulse train being formed by a time-sequence of substantially identical reference pulses, each reference pulse in said time-sequence of reference pulses exhibiting a half period waveform;
propagating, by said propagation device, said transmit signal towards a surface of said product in the tank;
propagating, by said propagation device, a surface reflection signal resulting from reflection of said transmit signal at said surface;
receiving, by said measurement circuitry, said surface reflection signal;
time-correlating, by said measurement circuitry, said surface reflection signal and said reference signal to form a measurement signal; and
determining, by said processing circuitry, said filling level based on said measurement signal.

17. The method according to claim 16, wherein said propagation device is a probe, and wherein said method further comprises the steps of:
non-conductively coupling said transmit signal between said pulse generating circuitry and said probe; and
non-conductively coupling said surface reflection signal between said probe and said measurement circuitry.

101-117. (canceled)
